(19) United States
(12) Patent Application Publication
(10) Pub. No.: US 2012/0304206 A1
(43) Pub. Date: Nov. 29, 2012

(54) Methods and Systems for Presenting an Advertisement Associated with an Ambient Action of a User

(75) Inventors: Brian F. Roberts, Dallas, TX (US); Anthony M. Lemus, Irving, TX (US); Michael D'Argenio, Green Brook, NJ (US); Donald H. Relyea, Dallas, TX (US)

(73) Assignee: VERIZON PATENT AND LICENSING, INC., Basking Ridge, NJ (US)

(21) Appl. No.: 13/116,784

(22) Filed: May 26, 2011

(51) Int. Cl. H04H 60/56; H04H 60/33

(52) U.S. Cl. 725/12; 725/10

(57) ABSTRACT

Exemplary targeted advertising systems and methods are disclosed herein. An exemplary method includes a media content presentation system presenting a media content program comprising an advertisement break, detecting an ambient action performed by a user during the presentation of the media content program, selecting an advertisement associated with the detected ambient action, and presenting the selected advertisement during the advertisement break. Corresponding methods and systems are also disclosed.

### BACKGROUND INFORMATION

The advent of set-top box devices and other media content access devices (“access devices”) has provided users with access to a large number and variety of media content choices. For example, a user may choose to experience a variety of broadcast television programs, pay-per-view services, video-on-demand programming, Internet services, and audio programming via a set-top box device. Such access devices have also provided service providers (e.g., television service providers) with an ability to present advertising to users. For example, designated advertisement channels may be used to deliver various advertisements to an access device for presentation to one or more users. In some examples, advertising may be targeted to a specific user or group of users of an access device.

However, traditional targeted advertising systems and methods may base targeted advertising solely on user profile information associated with a media content access device and/or user interactions directly with the media content access device. Accordingly, traditional targeted advertising systems and methods fail to account for one or more ambient actions of a user while the user is experiencing media content using a media content access device. For example, if a user is watching a television program, a traditional targeted advertising system fails to account for what the user is doing (e.g., eating, interacting with another user, sleeping, etc.) while the user is watching the television program. This limits the effectiveness, personalization, and/or adaptability of the targeted advertising.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary media content presentation system according to principles described herein.

FIG. 2 illustrates an exemplary implementation of the system of FIG. 1 according to principles described herein.

FIG. 3 illustrates an exemplary targeted advertising method according to principles described herein.

FIG. 4 illustrates an exemplary implementation of the system of FIG. 1 according to principles described herein.

FIG. 5 illustrates another exemplary targeted advertising method according to principles described herein.

FIG. 6 illustrates an exemplary computing device according to principles described herein.

### DETAILED DESCRIPTION OF PREFERRED EMBODIMENTS

Exemplary targeted advertisement methods and systems are disclosed herein. In accordance with principles described herein, an exemplary media content presentation system may be configured to provide targeted advertising in a personalized and dynamically adapting manner. In certain examples, the targeted advertising may be based on one or more ambient actions performed by one or more users of an access device. As described in more detail below, the media content presentation system may be configured to present a media content program comprising an advertisement break, detect an ambient action performed by a user during the presentation of the media content and within a detection zone associated with the media content presentation system, select an advertisement associated with the detected ambient action, and present the selected advertisement during the advertisement break. Accordingly, for example, a user may be presented with targeted advertising in accordance with the user's specific situation and/or actions.

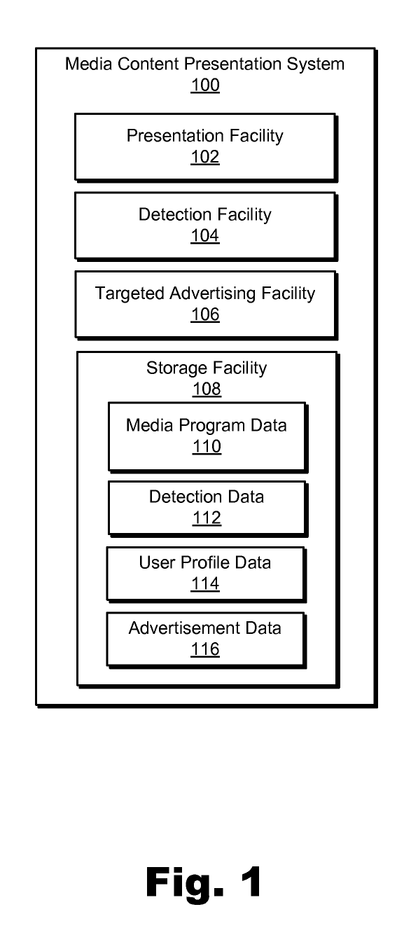

FIG. 1 illustrates an exemplary media content presentation system 100 (or simply “system 100”). As shown, system 100 may include, without limitation, a presentation facility 102, a detection facility 104, a targeted advertising facility 106 (or simply “advertising facility 106”), and a storage facility 108 selectively and communicatively coupled to one another. It will be recognized that although facilities 102-108 are shown to be separate facilities in FIG. 1, any of facilities 102-108 may be combined into fewer facilities, such as into a single facility, or divided into more facilities as may serve a particular implementation. Any suitable communication technologies, including any of the communication technologies mentioned herein, may be employed to facilitate communications between facilities 102-108.

Presentation facility 102 may be configured to present media content for experiencing by a user. A presentation of media content may be performed in any suitable way such as by generating and/or providing output signals representative of the media content to a display device (e.g., a television) and/or an audio output device (e.g., a speaker). Additionally or alternatively, presentation facility 102 may present media content by providing data representative of the media content to a media content access device (e.g., a set-top box device) configured to present (e.g., display) the media content.

As used herein, “media content” may refer generally to any media content accessible via a media content access device. The term “media content instance” and “media content program” will be used herein to refer to any television program, on-demand media program, pay-per-view media program, broadcast media program (e.g., broadcast television program), multicast media program (e.g., multicast television program), narrowcast media program (e.g., narrowcast video-on-demand program), IPTV media content, advertisement (e.g., commercial), video, movie, or any segment, component, or combination of these or other forms of media content that may be processed by a media content access device for experiencing by a user.

In some examples, presentation facility 102 may present a media content program (e.g., a television program) including one or more advertisement breaks during which presentation facility 102 may present one or more advertisements (e.g., commercials), as will be explained in more detail below.

Detection facility 104 may be configured to detect an ambient action performed by a user during the presentation of a media content program (e.g., by presentation facility 102). As used herein, the term “ambient action” may refer to any action performed by a user that is independent of and/or not directed at a media content access device presenting media content. For example, an ambient action may include any suitable action of a user during a presentation of a media content program by a media content access device, whether the user is actively experiencing (e.g., actively viewing) or passively experiencing (e.g., passively viewing and/or listening while the user is doing something else) the media content being presented.

To illustrate, an exemplary ambient action may include the user eating, exercising, laughing, reading, sleeping, talking, singing, humming, cleaning, playing a musical instrument, performing any other suitable action, and/or engaging in any other physical activity during the presentation of the media content. In certain examples, the ambient action may include an interaction by the user with another user (e.g., another user physically located in the same room as the user). To illustrate, the ambient action may include the user talking to, cuddling with, fighting with, wrestling with, playing a game with, competing with, and/or otherwise interacting with the other user. In further examples, the ambient action may include the user interacting with a separate media content access device (e.g., a media content access device separate from the media content access device presenting the media content). For example, the ambient action may include the user interacting with a mobile device (e.g., a mobile phone device, a tablet computer, a laptop computer, etc.) during the presentation of a media content program by a set-top box (“STB”) device.

Detection facility 104 may be configured to detect the ambient action in any suitable manner. In certain examples, detection facility 104 may utilize, implement, and/or be implemented by a detection device configured to detect one or more attributes of an ambient action, a user, and/or a user's surroundings. An exemplary detection device may include one or more sensor devices, such as an image sensor device (e.g., a camera device, such as a red green blue (“RGB”) camera or any other suitable camera device), a depth sensor device (e.g., an infrared laser projector combined with a complementary metal-oxide semiconductor (“CMOS”) sensor or any other suitable depth sensor and/or 3D imaging device), an audio sensor device (e.g., a microphone device such as a multi-array microphone or any other suitable microphone device), a thermal sensor device (e.g., a thermographic camera device or any other suitable thermal sensor device), and/or any other suitable sensor device or combination of sensor devices, as may serve a particular implementation. In certain examples, a detection device may be associated with a detection zone. As used herein, the term “detection zone” may refer to any suitable physical space, area, and/or range associated with a detection device, and within which the detection device may detect an ambient action, a user, and/or a user's surroundings.

In certain examples, detection facility 104 may be configured to obtain data (e.g., image data, audio data, 3D spatial data, thermal image data, etc.) by way of a detection device. For example, detection facility 104 may be configured to utilize a detection device to receive an RGB video stream, a monochrome depth sensing video stream, and/or a multi-array audio stream representative of persons, objects, movements, gestures, and/or sounds from a detection zone associated with the detection device.

Detection facility 104 may be additionally or alternatively configured to analyze data received by way of a detection device in order to obtain information associated with a user, an ambient action of the user, a user's surroundings, and/or any other information obtainable by way of the data. For example, detection facility 104 may analyze the received data utilizing one or more motion capture technologies, motion analysis technologies, gesture recognition technologies, facial recognition technologies, voice recognition technologies, acoustic source localization technologies, and/or any other suitable technologies to detect one or more actions (e.g., movements, motions, gestures, mannerisms, etc.) of the user, a location of the user, a proximity of the user to another user, one or more physical attributes (e.g., size, build, skin color, hair length, facial features, and/or any other suitable physical attributes) of the user, one or more voice attributes (e.g., tone, pitch, inflection, language, accent, amplification, and/or any other suitable voice attributes) associated with the user's voice, one or more physical surroundings of the user (e.g., one or more physical objects proximate to and/or held by the user), and/or any other suitable information associated with the user.

Detection facility 104 may be further configured to utilize the detected data to determine an ambient action of the user (e.g., based on the actions, motions, and/or gestures of the user), determine whether the user is an adult or a child (e.g., based on the physical attributes of the user), determine an identity of the user (e.g., based on the physical and/or voice attributes of the user and/or a user profile associated with the user), determine a user's mood (e.g., based on the user's tone of voice, mannerisms, demeanor, etc.), and/or make any other suitable determination associated with the user, the user's identity, the user's actions, and/or the user's surroundings. If multiple users are present, detection facility 104 may analyze the received data to obtain information associated with each user individually and/or the group of users as a whole.

To illustrate, detection facility 104 may detect that a user is singing or humming a song. Using any suitable signal processing heuristic, detection facility 104 may identify a name, genre, and/or type of the song. Based on this information, detection facility 104 may determine that the user is in a particular mood. For example, the user may be singing or humming a generally “happy” song. In response, detection facility 104 may determine that the user is in a cheerful mood. Accordingly, one or more advertisements may be selected for presentation to the user that are configured to target happy people. It will be recognized that additional or alternative ambient actions performed by a user (e.g., eating, exercising, laughing, reading, cleaning, playing a musical instrument, etc.) may be used to determine a mood of the user and thereby select an appropriate advertisement for presentation to the user.

In some examples, detection facility 104 may determine, based on data received by way of a detection device, that a user is holding and/or interacting with a mobile device. For example, detection facility 104 may determine that the user is sitting on a couch and interacting with a tablet computer during the presentation of a television program being presented by a STB device. In some examples, detection facility 104 may be configured to communicate with the mobile device in order to receive data indicating what the user is doing with the mobile device (e.g., data indicating that the user is utilizing the mobile device to browse the web, draft an email, review a document, read an e-book, etc.) and/or representative of content that the user is interacting with (e.g., representative of one or more web pages browsed by the user, an email drafted by the user, a document reviewed by the user, an e-book read by the user, etc.).

Additionally or alternatively, detection facility 104 may be configured to detect and/or identify any other suitable animate and/or inanimate objects. For example, detection facility 104 may be configured to detect and/or identify an animal (e.g., a dog, cat, bird, etc.), a retail product (e.g., a soft drink can, a bag of chips, etc.), furniture (e.g., a couch, a chair, etc.), a decoration (e.g., a painting, a photograph, etc.), and/or any other suitable animate and/or inanimate objects.

Advertising facility 106 may be configured to select an advertisement based on information obtained by detection facility 104. For example, advertising facility 106 may be configured to select an advertisement based on an ambient action of a user, an identified mood of a user, an identity of a user, and/or any other suitable information detected/obtained by detection facility 104, as explained above. Advertising facility 106 may select an advertisement for presentation to a user in any suitable manner. For example, advertising facility 106 may perform one or more searches of an advertisement database to select an advertisement based on information received from detection facility 104. Additionally or alternatively, advertising facility 106 may analyze metadata associated with one or more advertisements to select an advertisement based on information obtained by detection facility 104.

To illustrate the foregoing, in some examples, each ambient action may be associated with one or more terms or keywords (e.g., as stored in a reference table that associates ambient actions with corresponding terms/keywords). As a result, upon a detection of a particular ambient action, advertising facility 106 may utilize the terms and/or keywords associated with the detected ambient action to search the metadata of and/or search a reference table associated with one or more advertisements. Based on the search results, advertising facility 106 may select one or more advertisements (e.g., one or more advertisements having one or more metadata values matching a term/keyword associated with the detected ambient action). In additional or alternative examples, a particular ambient action may be directly associated with one or more advertisements (e.g., by way of an advertiser agreement). For example, an advertiser may designate a particular ambient action to be associated with the advertiser's advertisement and, upon a detection of the particular ambient action, advertising facility 106 may select the advertiser's advertisement for presentation to the user. Additionally or alternatively, the advertisement selections of advertising facility 106 may be based on a user profile associated with an identified user, one or more words spoken by a user, a name or description of a detected object (e.g., a detected retail product, a detected animal, etc.), and/or any other suitable information, terms, and/or keywords detected and/or resulting from the detections of detection facility 104.

In accordance with the foregoing, advertising facility 106 may select an advertisement that is specifically targeted to the user based on what the user is doing, who the user is, the user's surroundings, and/or any other suitable information associated with the user, thereby providing the user with advertising content that is relevant to the user's current situation and/or likely to be of interest to the user. If a plurality of users are present, advertising facility 106 may select an advertisement targeted to a particular user in the group based on information associated with and/or an ambient action of the particular user and/or select an advertisement targeted to the group as a whole based on the combined information associated with each of the users and/or their interaction with each other.

Various examples of advertisement selections by advertising facility 106 will now be provided. While certain examples are provided herein for illustrative purposes, one will appreciate that advertising facility 106 may be configured to select any suitable advertisement based on any suitable information obtained from detection facility 104 and/or associated with a user.

In some examples, if detection facility 104 determines that a user is exercising (e.g., running on a treadmill, doing aerobics, lifting weights, etc.), advertising facility 106 may select an advertisement associated with exercise in general, a specific exercise being performed by the user, and/or any other advertisement (e.g., an advertisement for health food) that may be intended for people who exercise. Additionally or alternatively, if detection facility 104 detects that a user is playing with a dog, advertising facility 106 may select an advertisement associated with dogs (e.g., a dog food commercial, a flea treatment commercial, etc.). Additionally or alternatively, if detection facility 104 detects one or more words spoken by a user (e.g., while talking to another user within the same room or on the telephone), advertising facility 106 may utilize the one or more words spoken by the user to search for and/or select an advertisement associated with the one or more words. Additionally or alternatively, if detection facility 104 detects that a couple is arguing/fighting with each other, advertising facility 106 may select an advertisement associated marriage/relationship counseling. Additionally or alternatively, if detection facility 104 identifies a user, advertising facility 106 may select an advertisement based on user profile information associated with the user (e.g., information associated with the user's preferences, traits, tendencies, etc.). Additionally or alternatively, if detection facility 104 detects that a user is a young child, advertising facility 106 may select one or more advertisements targeted to and/or appropriate for young children. Additionally or alternatively, if detection facility 104 detects a particular object (e.g., a Budweiser can) within a user's surroundings, advertising facility 106 may select an advertisement associated with the detected object (e.g., a Budweiser commercial). Additionally or alternatively, if detection facility 104 detects a mood of a user (e.g., that the user is stressed), advertising facility 106 may select an advertisement associated with the detected mood (e.g., a commercial for a stress-relief product such as aromatherapy candles, a vacation resort, etc.).

Advertising facility 106 may be configured to direct presentation facility 102 to present a selected advertisement during an advertisement break. In certain examples, advertising facility 106 may be configured to detect an upcoming advertisement break and direct presentation facility 102 to present the selected advertisement during the detected advertisement break in any suitable manner. For example, advertising facility 106 may be configured to transmit data representative of a selected advertisement to presentation facility 102, dynamically insert the selected advertisement onto an advertisement channel accessible by presentation facility 102, and/or direct presentation facility 102 to tune to an advertisement channel carrying the selected advertisement.

In some examples, advertising facility 106 may be configured to direct a mobile device associated with the user to present a selected advertisement. For example, if detection facility 104 detects that the user is holding a mobile device, advertising facility 106 may be configured to communicate with the mobile device to direct the mobile device to present the selected advertisement. Accordingly, not only may the selected advertisement be specifically targeted to the user, but it may also be delivered right to the user's hands.

System 100 may be configured to perform any other suitable operations in accordance with information detected or otherwise obtained by detection facility 104. For example, system 100 may be configured to selectively activate one or more parental control features in accordance with information detected by detection facility 104. To illustrate, if detection facility 104 detects that a small child is present and/or interacting with a mobile device, system 100 may automatically activate one or more parental control features associated with presentation facility 102 and/or the mobile device. For example, system 100 may limit the media content presented by presentation facility 102 and/or communicate with the mobile device to limit the content accessible by way of the mobile device (e.g., so that the child is not presented with or able to access content that is not age appropriate). In certain examples, system 100 may lock presentation facility 102, a corresponding media content access device, and/or the mobile device completely. Additionally or alternatively, system 100 may be configured to dynamically adjust parental control features as children of different ages enter and/or leave a room (e.g., as detected by detection facility 104).

Additionally or alternatively, system 100 may utilize the information detected or otherwise obtained by detection facility 104 to provide one or more media content recommendations to a user. For example, system 100 may suggest one or more television programs, movies, and/or any other suitable media content as possibly being of interest to the user based on the information obtained by detection facility 104. If multiple users are present, system 100 may provide personalized media content recommendations for each user present. In certain examples, system 100 may be configured to provide the media content recommendations by way of a mobile device being utilized by a user.

Storage facility 108 may be configured to maintain media program data 110 representative of one or more media content programs, detection data 112 representative of data and/or information detected/obtained by detection facility 104, user profile data 114 representative of user profile information associated with one or more users, and advertisement data 116 representative of one or more advertisements. Storage facility 108 may be configured to maintain additional or alternative data as may serve a particular implementation.

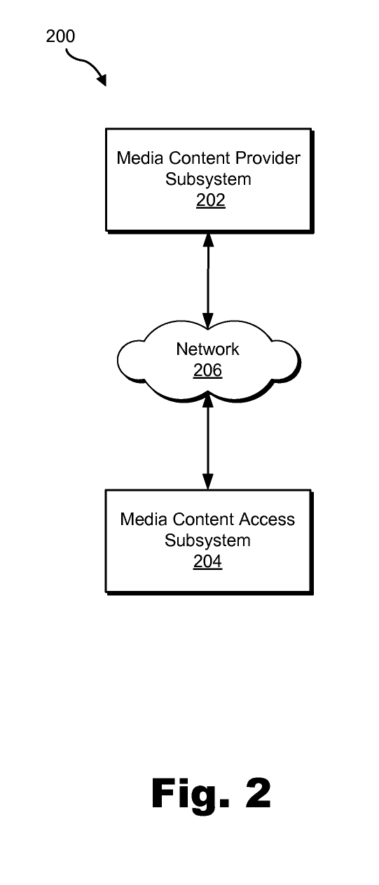

FIG. 2 illustrates an exemplary implementation 200 of system 100 wherein a media content provider subsystem 202 (or simply “provider subsystem 202”) is communicatively coupled to a media content access subsystem 204 (or simply “access subsystem 204”). As will be described in more detail below, presentation facility 102, detection facility 104, advertising facility 106, and storage facility 108 may each be implemented on one or both of provider subsystem 202 and access subsystem 204.

Provider subsystem 202 and access subsystem 204 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

In certain embodiments, provider subsystem 202 and access subsystem 204 may communicate via a network 206, which may include one or more networks, including, but not limited to, wireless networks (Wi-Fi networks), wireless data communication networks (e.g., 3G and 4G networks), mobile telephone networks (e.g., cellular telephone networks), closed media networks, open media networks, closed communication networks, open communication networks, satellite networks, navigation networks, broadband networks, narrowband networks, voice communication networks (e.g., VoIP networks), the Internet, local area networks, and any other networks capable of carrying data and/or communications signals between provider subsystem 202 and access subsystem 204. Communications between provider subsystem 202 and access subsystem 204 may be transported using any one of the above-listed networks, or any combination or sub-combination of the above-listed networks.

While FIG. 2 shows provider subsystem 202 and access subsystem 204 communicatively coupled via network 206, it will be recognized that provider subsystem 202 and access subsystem 204 may be configured to communicate one with another in any other suitable manner (e.g., via a direct connection).

Provider subsystem 202 may be configured to generate or otherwise provide media content (e.g., in the form of one or more media content streams including one or more media content instances) to access subsystem 204. In certain examples, provider subsystem 202 may additionally or alternatively be configured to provide one or more advertisements to access subsystem 204 (e.g., by way of one or more advertising channels). Additionally or alternatively, provider subsystem 202 may be configured to facilitate dynamic insertion of one or more advertisements (e.g., targeted advertisements) onto one or more or advertisement channels delivered to access subsystem 204.

Access subsystem 204 may be configured to facilitate access by a user to media content received from provider subsystem 202. To this end, access subsystem 204 may present the media content for experiencing (e.g., viewing) by a user, record the media content, and/or analyze data (e.g., metadata) associated with the media content. Presentation of the media content may include, but is not limited to, displaying, playing, or otherwise presenting the media content, or one or more components of the media content, such that the media content may be experienced by the user.

In certain embodiments, system 100 may be implemented entirely by or within provider subsystem 202 or access subsystem 204. In other embodiments, components of system 100 may be distributed across provider subsystem 202 and access subsystem 204. For example, access subsystem 204 may include a client (e.g., a client application) implementing one or more of the facilities of system 100.

Provider subsystem 202 may be implemented by one or more computing devices. For example, provider subsystem 202 may be implemented by one or more server devices. Additionally or alternatively, access subsystem 204 may be implemented as may suit a particular implementation. For example, access subsystem 204 may be implemented by one or more media content access devices, which may include, but are not limited to, a set-top box device, a DVR device, a media content processing device, a communications device, a mobile access device (e.g., a mobile phone device, a handheld device, a laptop computer, a tablet computer, a personal-digital assistant device, a camera device, etc.), a personal computer, a gaming device, a television device, and/or any other device configured to perform one or more of the processes and/or operations described herein. In certain examples, access subsystem 204 may be additionally or alternatively implemented by one or more detection and/or sensor devices.

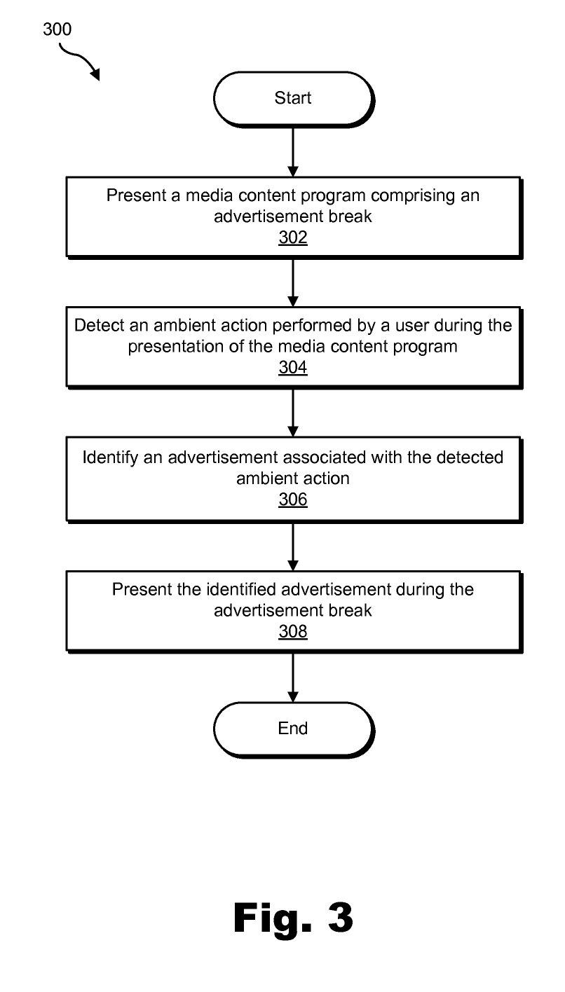

FIG. 3 illustrates an exemplary targeted advertising method 300. While FIG. 3 illustrates exemplary steps according to one embodiment, other embodiments may omit, add to, reorder, and/or modify any of the steps shown in FIG. 3. The steps shown in FIG. 3 may be performed by any component or combination of components of system 100.

In step 302, a media content presentation system presents a media content program comprising an advertisement break. For example, presentation facility 102 and/or access subsystem 204 may be configured to present the media content program in any suitable manner, such as disclosed herein.

In step 304, the media content presentation system detects an ambient action performed by a user during the presentation of the media content program. For example, the ambient action may include any suitable ambient action performed by the user, and detection facility 104 may be configured to detect the ambient action in any suitable manner, such as disclosed herein.

In step 306, the media content presentation system selects an advertisement associated with the detected ambient action. For example, advertising facility 106 may be configured to select the advertisement in any suitable manner, such as disclosed herein.

In step 308, the media content presentation system presents the selected advertisement during the advertisement break. For example, presentation facility 102 may be configured to present the selected advertisement during the advertisement break in any suitable manner, such as disclosed herein.

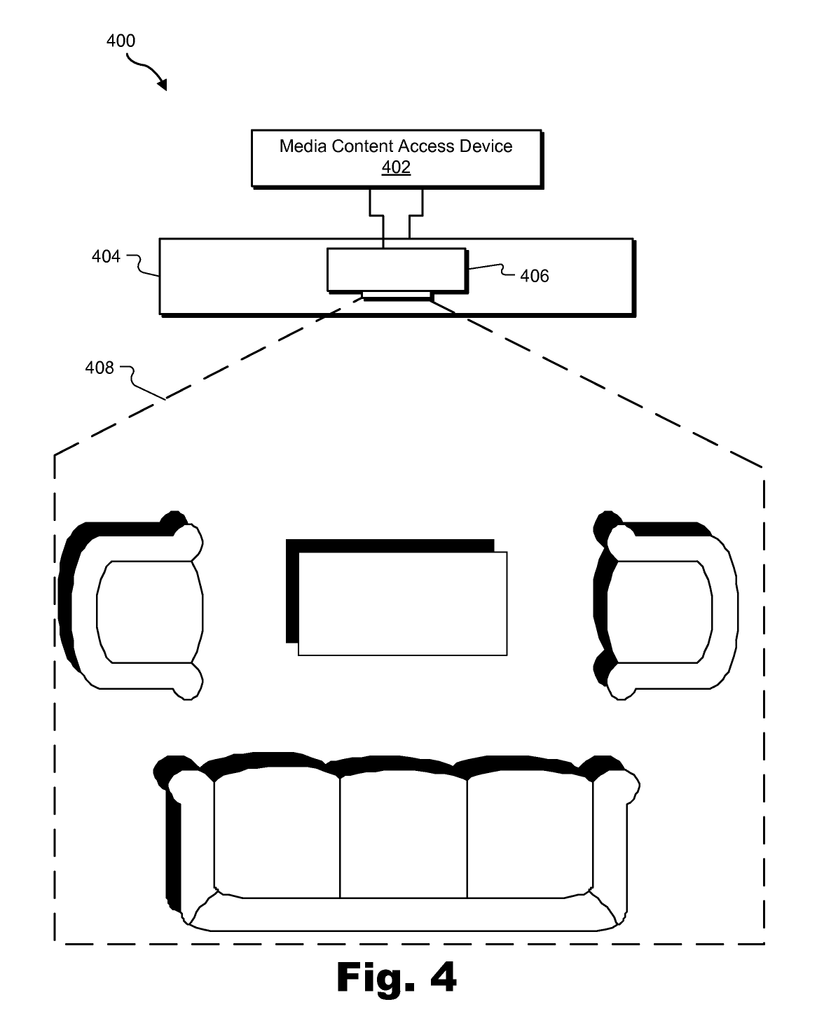

To illustrate the foregoing steps, FIG. 4 illustrates an exemplary implementation 400 of system 100 and/or access subsystem 204. As shown, implementation 400 may include a media content access device 402 (e.g., a STB device) communicatively coupled to a display device 404 and a detection device 406. As shown, detection device 406 may be associated with a detection zone 408, within which detection device 406 may detect an ambient action of a user and/or any other suitable information associated with the user and/or detection zone 408. To illustrate, detection zone 408 may include at least a portion of a room (e.g., a living room) within a user's home where access device 402, display device 404, and/or detection device 406 are located. Detection device 406 may include any suitable sensor devices, such as disclosed herein. In some examples, detection device 406 may include an image sensor device, a depth sensor device, and an audio sensor device.

Access device 402 may be configured to present a media content program by way of display device 404. For example, access device 402 may be configured to present a television program including one or more advertisement breaks by way of display device 404 for experiencing by one or more users within detection zone 408. During the presentation of the television program, access device 402 may be configured to utilize detection device 406 to detect an ambient action of a user watching the television program. To illustrate, access device 402 may detect, by way of detection device 406, that two users are cuddling on a couch during the presentation of the television program and prior to an advertisement break. Based on the detected ambient action, access device 402 and/or a corresponding server device (e.g., implemented by provider subsystem 202) may select an advertisement associated with the ambient action. In some examples, access device 402 and/or the corresponding server device may utilize one or more terms associated with the detected ambient action (e.g., in accordance with a corresponding reference table) to search for and/or select an advertisement associated with the detected ambient action. To illustrate, access device 402 and/or the corresponding server device may utilize one or more terms associated with cuddling (e.g., the terms “romance,” “love,” “cuddle,” “snuggle,” etc.) to search for and/or select a commercial associated with cuddling (e.g., a commercial for a romantic getaway vacation, a commercial for a contraceptive, a commercial for flowers, a commercial including a trailer for an upcoming romantic comedy movie, etc.). Thereafter, access device 402 may present the selected advertisement by way of display device 404 during the advertisement break for experiencing by the users.

The foregoing example is provided for illustrative purposes only. One will appreciate that method 300 may be implemented in any other suitable manner, such as disclosed herein.

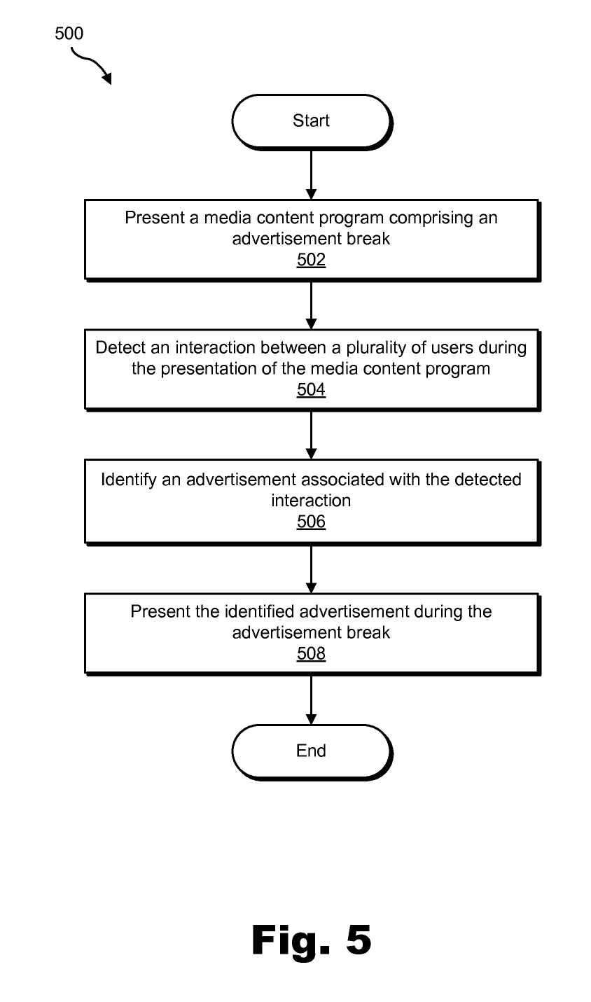

FIG. 5 illustrates another exemplary targeted advertising method 500. While FIG. 5 illustrates exemplary steps according to one embodiment, other embodiments may omit, add to, reorder, and/or modify any of the steps shown in FIG. 5. The steps shown in FIG. 5 may be performed by any component or combination of components of system 100.

In step 502, a media content presentation system presents a media content program comprising an advertisement break. For example, presentation facility 102 may be configured to present the media content program in any suitable manner, such as disclosed herein.

In step 504, the media content presentation system detects an interaction between a plurality of users during the presentation of the media content program. For example, detection facility 104 may detect the interaction in any suitable manner, such as disclosed herein.

In step 506, the media content presentation system selects an advertisement associated with the detected interaction. For example, advertising facility 106 may be configured to select the advertisement in any suitable manner, such as disclosed herein.

In step 508, the media content presentation system presents the selected advertisement during the advertisement break. For example, presentation facility 102 may be configured to present the selected advertisement during the advertisement break in any suitable manner, such as disclosed herein.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

In certain embodiments, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

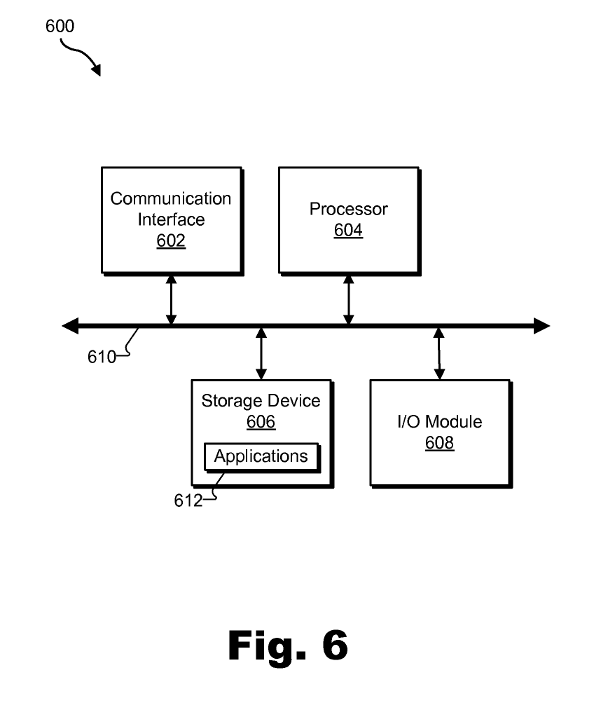

FIG. 6 illustrates an exemplary computing device 600 that may be configured to perform one or more of the processes described herein. As shown in FIG. 6, computing device 600 may include a communication interface 602, a processor 604, a storage device 606, and an input/output (“I/O”) module 608 communicatively connected via a communication infrastructure 610. While an exemplary computing device 600 is shown in FIG. 6, the components illustrated in FIG. 6 are not intended to be limiting. Additional or alternative components may be used in other embodiments. Components of computing device 600 shown in FIG. 6 will now be described in additional detail.

Communication interface 602 may be configured to communicate with one or more computing devices. Examples of communication interface 602 include, without limitation, a wired network interface (such as a network interface card), a wireless network interface (such as a wireless network interface card), a modem, and any other suitable interface. Communication interface 602 may be configured to interface with any suitable communication media, protocols, and formats, including any of those mentioned above. In at least one embodiment, communication interface 602 may provide a communicative connection between mobile device 200 and one or more separate media content access devices, a program guide information provider, and a media content provider.

Processor 604 generally represents any type or form of processing unit capable of processing data or interpreting, executing, and/or directing execution of one or more of the instructions, processes, and/or operations described herein. Processor 604 may direct execution of operations in accordance with one or more applications 612 or other computer-executable instructions such as may be stored in storage device 606 or another computer-readable medium.

Storage device 606 may include one or more data storage media, devices, or configurations and may employ any type, form, and combination of data storage media and/or device. For example, storage device 606 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 606. For example, data representative of one or more executable applications 612 (which may include, but are not limited to, one or more of the software applications described herein) configured to direct processor 604 to perform any of the operations described herein may be stored within storage device 606. In some examples, data may be arranged in one or more databases residing within storage device 606.

I/O module 608 may be configured to receive user input and provide user output and may include any hardware, firmware, software, or combination thereof supportive of input and output capabilities. For example, I/O module 608 may include hardware and/or software for capturing user input, including, but not limited to, a keyboard or keypad, a touch screen component (e.g., a touch screen display), a receiver (e.g., an RF or infrared receiver), and/or one or more input buttons.

I/O module 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 608 is configured to provide graphical data to a display for presentation to a user. The graphical data may be representative of one or more graphical user interfaces (e.g., program guide interfaces) and/or any other graphical content as may serve a particular implementation.

In some examples, any of the features described herein may be implemented and/or performed by one or more components of computing device 600. For example, one or more applications 612 residing within storage device 606 may be configured to direct processor 604 to perform one or more processes or functions associated with presentation facility 102, detection facility 104, and/or advertising facility 106. Likewise, storage facility 108 may be implemented by or within storage device 606.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
presenting, by a media content presentation system, a media content program comprising an advertisement break;
detecting, by the media content presentation system, an ambient action performed by a user during the presentation of the media content program and within a detection zone associated with the media content presentation system;
selecting, by the media content presentation system, an advertisement associated with the detected ambient action; and
presenting, by the media content presentation system, the selected advertisement during the advertisement break.

2. The method of claim 1, wherein the ambient action comprises at least one of eating, exercising, laughing, reading, sleeping, talking, singing, humming, cleaning, and playing a musical instrument.

3. The method of claim 1, wherein the ambient action comprises an interaction between the user and another user.

4. The method of claim 3, wherein the interaction between the user and the another user comprises at least one of cuddling, fighting, participating in a game or sporting event, and talking.

5. The method of claim 1, wherein the ambient action comprises an interaction by the user with a separate mobile device.

6. The method of claim 5, wherein the presenting of the selected advertisement comprises directing the separate mobile device to present the selected advertisement.

7. The method of claim 5, wherein
the detecting of the ambient action comprises communicating with the separate mobile device to obtain information associated with the user's interaction with the separate mobile device; and
the selecting comprises utilizing the information obtained from the separate mobile device to select the advertisement.

8. The method of claim 1, wherein the detecting comprises utilizing at least one of a gesture recognition technology, a profile recognition technology, a facial recognition technology, and a voice recognition technology.

9. The method of claim 1, further comprising:
identifying, by the media content presentation system, the user;
wherein the selecting of the advertisement is based at least partially on a user profile associated with the identified user.

10. The method of claim 1, further comprising:
determining, by the media content presentation system, a mood of the user in accordance with the detected ambient action;
wherein the selecting of the advertisement comprises selecting the advertisement based on the determined mood of the user.

11. The method of claim 1, further comprising identifying, by the media content presentation system, one or more physical attributes associated with the user.

12. The method of claim 11, wherein the selecting of the advertisement is at least partially based on the identified one or more physical attributes associated with the user.

13. The method of claim 11, further comprising selectively activating, by the media content presentation system, one or more parental control features in response to the identifying of the one or more physical attributes associated with the user.

14. The method of claim 1, wherein:
the detecting of the ambient action comprises detecting at least one word spoken by the user; and
the selected advertisement is associated with the at least one word spoken by the user.

15. The method of claim 1, further comprising detecting, by the media content presentation system, a presence of a physical object within the detection zone, wherein the advertisement is further associated with the detected physical object.

16. The method of claim 1, embodied as computer-executable instructions on at least one non-transitory computer-readable medium.

17. A method comprising:
presenting, by a media content presentation system, a media content program comprising an advertisement break;
detecting, by the media content presentation system by way of a detection device, an interaction between a plurality of users during the presentation of the media content program and within a detection zone associated with the media content presentation system;
selecting, by the media content presentation system, an advertisement associated with the detected interaction; and
presenting, by the media content presentation system, the selected advertisement during the advertisement break.

18. The method of claim 17, embodied as computer-executable instructions on at least one non-transitory computer-readable medium.

19. A system comprising:
a presentation facility configured to present a media program comprising an advertisement break;
a detection facility communicatively coupled to the presentation facility and configured to detect an ambient action performed by a user during the presentation of the media content program and within a detection zone; and
a targeted advertising facility communicatively coupled to the detection facility and configured to
select an advertisement associated with the detected ambient action, and
direct the presentation facility to present the selected advertisement during the advertisement break.

20. The system of claim 19, wherein the detection facility is implemented by a detection device comprising at least one of a depth sensor, an image sensor, an audio sensor, and a thermal sensor.
